(19) United States
(12) Patent Application Publication
(10) Pub. No.: US 2022/0376336 A1
(43) Pub. Date: Nov. 24, 2022

(54) BATTERY MODULE AND BATTERY PACK INCLUDING THE SAME

(71) Applicant: LG Energy Solution, LTD., Seoul (KR)

(72) Inventors: Sunghwan Jang, Daejeon (KR); Junyeob Seong, Daejeon (KR); Min Seop Kim, Daejeon (KR)

(21) Appl. No.: 17/793,332

(22) PCT Filed: Feb. 2, 2021
(86) PCT No.: PCT/KR2021/001335

§ 371 Date: Jul. 15, 2022

(30) Foreign Application Priority Data
Apr. 29, 2020 (KR) 10-2020-0052249

(51) Int. Cl. H01M 50/211; H01M 50/30; H01M 50/24

(52) U.S. Cl. CPC H01M 50/211; H01M 50/394; H01M 50/24

(57) ABSTRACT

A battery module including a stack of battery cells, a U-shaped frame that accommodates the stack of battery cells and has an opened upper part, and at least two upper plates covering a part of the stack of battery cells at the opened upper part of the U-shaped frame is provided.

### CROSS-REFERENCE TO RELATED APPLICATION

This application is a National Stage Application of International Application No. PCT/KR2021/001335, filed on Feb. 2, 2021, which claims priority to and the benefit of Korean Patent Application No. 10-2020-0052249 filed on Apr. 29, 2020, the disclosures of which are incorporated herein by reference in their entirety.

### FIELD OF DISCLOSURE

The present disclosure relates to a battery module and a battery pack including the same. More particularly, the present disclosure relates to a battery module that is easy to be assembled and may reduce a cost and a battery pack including the same.

### BACKGROUND

Rechargeable batteries having high application characteristics and electrical characteristics such as high energy density according to their products are widely applied to battery vehicles, hybrid vehicles, and electric power storage devices driven by electric driving sources as well as portable devices. These rechargeable batteries are attracting attention as new energy sources for improving environmentally-friendliness and energy efficiency in that they do not generate any by-products of energy use as well as their primary merit, in which they can drastically reduce the use of fossil fuels.

In small mobile devices, one, or two, or three battery cells are used per device, while medium and large devices such as automobiles require high power/large capacity. Therefore, a medium-to-large battery module in which a plurality of battery cells are electrically connected is used.

Since it is preferable for medium and large battery modules to be manufactured with as small a size and weight as possible, a prismatic battery and a pouch-type battery, which may have a high integration degree and have a small weight with respect to capacity, are mainly used as a battery cell of the medium and large battery modules. Meanwhile, in order to protect the cell laminated body from external impact, heat, or vibration, the battery module may include a frame member that receives the battery cell laminated body in an internal space with front and rear openings.

As such a frame member, a module frame formed to form a tube shape by combining a U-shaped frame and an upper plate covering the opened upper part of the U-shaped frame may be applied. In order to form such a module frame, in a state in which the battery cell stack is mounted inside the U-shaped frame of the module frame, the U-shaped frame and the upper plate may be coupled by a welding or the like. At this time, in the conventional structure in which the upper plate covers the entire opened upper surface of the U-shaped frame, there were problems such as increasing of welding points for bonding the upper plate and the U-shaped frame and having to provide a separate configuration for discharging. a flame or high temperature/high-pressure gas that may occur when a thermal runaway occurs in some cells.

### SUMMARY

The problem to be solved by the present disclosure is to provide a battery module and a battery pack including the same that may improve an assemble ability, reduce a cost, and simultaneously secure a safety.

However, objects to be solved by the embodiments of the present disclosure are not limited to the above-mentioned problems and can be variously extended within the scope of the technical idea included in the present disclosure.

A battery module according to an exemplary embodiment of the present disclosure includes a stack of battery cells; a U-shaped frame that accommodates the stack of battery cells and has an opened upper part; and at least two upper plates covering a part of the stack of battery cells at the opened upper part of the U-shaped frame.

The part where two adjacent upper plates among the at least two the upper plates are spaced apart from each other may exist as an empty space.

The upper plate may be a strap shape such that both ends of the upper plate are joined to upper part of the U-shaped frame.

The upper plate may include a coupling portion extending toward the U-shaped frame at both ends.

The coupling portion of the upper plate and the U-shaped frame may be coupled by any one of a welding, a bolting, an adhesive, and a snap fit.

The coupling portion of the upper plate and the U-shaped frame may be coupled by a snap fit, the coupling portion may include a hook portion in which a protrusion protruded toward the stack of battery cells is formed, and the U-shaped frame may include a coupling hole that engages the protrusion.

The empty space may act as a vent hole.

A protection sheet disposed between the upper plate and the stack of battery cells may be further included.

A battery pack according to another exemplary embodiment of the present disclosure includes the battery module.

A device according to another exemplary embodiment of the present disclosure may include at least one battery pack above-described.

### Advantageous Effects

According to exemplary embodiments of the present disclosure, by configuring the upper plate of the module frame as a plurality of upper plate covering the part of the stack of battery cells, it is possible to improve the efficiency of the assembly and reduce the cost.

In addition, when an issue such as thermal runaway occurs in the stack of battery cells, the generated flame, high temperature/high pressure gas may be efficiently discharged, thereby improving the safety of the battery module.

The above effects desired to be achieved in the present disclosure are not limited to the aforementioned effects, and other effects not described above will be apparent to those skilled in the art from the disclosure of the present disclosure.

### DESCRIPTION OF THE DRAWINGS

FIG. 1 is an exploded perspective view of a battery module according to an exemplary embodiment of the present disclosure.

FIG. 2 is a view showing a shape in which configurations of a battery module in FIG. 1 are assembled.

FIG. 3 is a view for explaining a case in which a thermal runaway occurs in a battery module according to an exemplary embodiment of the present disclosure.

FIG. 4 is a perspective view of a battery module according to a comparative example.

FIG. 5 is an exploded perspective view of a battery module according to another exemplary embodiment of the present disclosure.

### DETAILED DESCRIPTION

It should be understood that the exemplary embodiment described below is illustratively shown to help the understanding of the disclosure, and the present disclosure may be implemented with various modifications different from the exemplary embodiment described herein. However, when it is determined that a detailed description of a related known function or constituent element in describing the present disclosure may unnecessarily obscure the gist of the present disclosure, the detailed description and detailed illustration thereof will be omitted. In addition, the accompanying drawings are not drawn into an actual scale, but dimensions of some constituent elements may be exaggerated in order to help the understanding of the disclosure.

The terms first and second used in this application may be used to describe various configurations elements, but the constituent elements should not be limited by the terms. The above terms are used only for distinguishing one constituent element from other constituent elements.

In addition, the terms used in the present application are used only to describe specific exemplary embodiments, and are not intended to limit the scope. When explaining the singular, unless explicitly described to the contrary, it may be interpreted as a plural meaning. In the present application, terms such as “comprise”, “consisting of” or “consisting” are intended to designate that features, numbers, steps, operations, constituent elements, parts, or combinations thereof described in the specification exist, one or the other. It should be understood that the existence or addition of the above other features, numbers, steps, operations, constituent elements, parts, or combinations thereof is not excluded in advance.

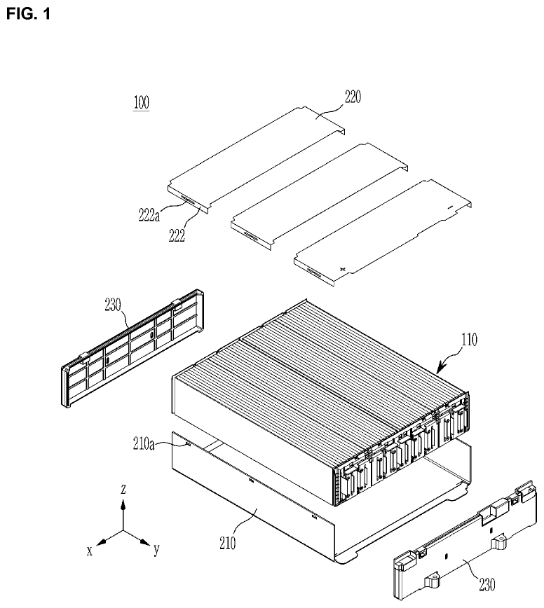

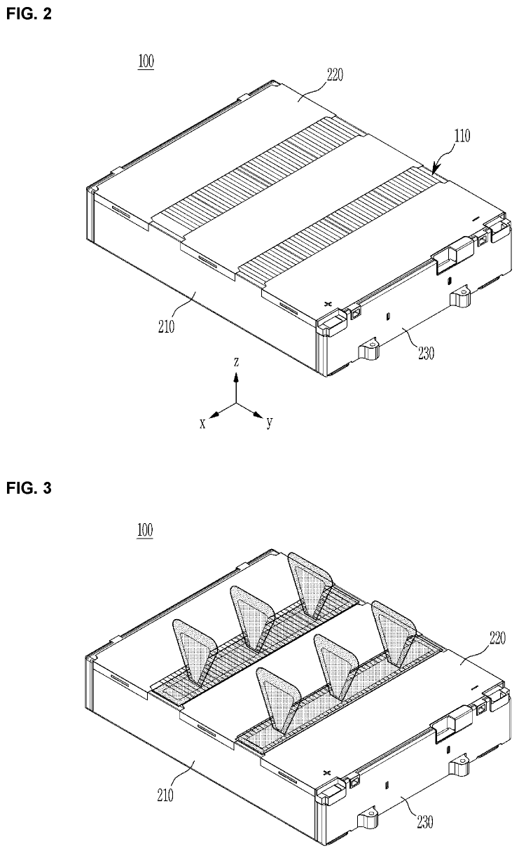

Hereinafter, a configuration of a battery module according to an exemplary embodiment of the present disclosure is described with reference to FIG. 1 and FIG. 2.

FIG. 1 is an exploded perspective view of a battery module according to an exemplary embodiment of the present disclosure. FIG. 2 is a view showing a shape in which configurations of a battery module in FIG. 1 are assembled.

Referring to FIG. 1 and FIG. 2, the battery module 100 according to an exemplary embodiment of the present disclosure includes a stack of battery cells 110, and a module frame 210 and 220 of accommodating the stack of battery cells 110.

The battery cell according to the present exemplary embodiment is a reachable battery and may be configured as a pouch-type reachable battery. Such battery cells may be configured in a plurality, and a plurality of battery cells may be stacked to each other to be electrically connected to each other to form a stack of battery cells 110. A plurality of battery cells may include an electrode lead protruded from an electrode assembly, a cell case, and an electrode assembly, respectively.

The module frame 210 and 220 accommodates the stack of battery cells 110. According to an exemplary embodiment of the present disclosure, the module frame 210 and 220 may include a U-shaped frame 210 that covers the lower surface and both sides of the stack of battery cells 110, and at least two upper plate 220 that are disposed to the upper surface of the stack of battery cells 110 plate 220.

The battery module 100 according to the present exemplary embodiment may further include an end plate 230 covering the front and rear surfaces of the stack of battery cells 110. It is possible to physically protect the stack of battery cells 110 accommodated therein through the module frames 210 and 220 described above. Meanwhile, although not specifically illustrated, a bus bar frame on which a bus bar is mounted and an insulating cover for an electrical insulation may be positioned between the stack of battery cells 110 and the end plate 230.

The U-shaped frame 210 of the module frame 210 and 220 accommodating the stack of battery cells 110 may include a bottom part and two side parts extending toward from both ends of the bottom part. The bottom part may cover the lower surface of the stack of battery cells 110 (the opposite direction to a z-axis), and the side parts may cover both sides of the stack of battery cells 110 (the x-axis direction and the opposite direction thereof). Meanwhile, although not specifically shown, a heat sink capable of cooling a heat from the battery module 100 by injecting a refrigerant, etc., may be integrally formed on the lower surface of the bottom part of the U-shaped frame. In addition, although not specifically shown, a thermal conductive resin layer including a thermal conductive resin may be positioned between the bottom part of the U-shaped frame 210 and the stack of battery cells 110. The thermal conductive resin may include a thermal conductive adhesive material, specifically, at least one of a silicone material, a urethane material, and an acrylic material. The thermal conductive resin may be liquid during the coating, but is cured after the coating, thereby serving to fix at least one battery cell 110 constituting the stack of battery cells 120

In addition, it has excellent thermal conductive characteristics, so that the heat generated by the battery cell may be quickly transferred to the lower side of the battery module 100.

The upper plate 220 may be disposed on the rest upper surface (the z-axis direction) except for the lower surface and the both sides covered by the U-shaped frame 210. At least two upper plates 220 may be provided, and one upper plate 220 may be formed in a strap shape that covers the part of the stack of battery cells 110. That is, it may have a rectangular strap shape formed long in the x-axis direction in the drawing.

At least two upper plates 220 (three upper plates 220 in the drawing) may be disposed to be spaced apart from each other. That is, they are spaced apart from each other in the y-axis direction in the drawing. As shown in the drawing, an empty space may exist between the upper plates 220 spaced apart from each other. In this specification, it has been described as an example that three upper plates 220 are provided and there are two empty spaces, but the present disclosure is not limited thereto and may be appropriately selected in consideration of the size of the battery module 100 and the like. By having such an empty space, the weight of the module frames 210 and 220 as a whole may be reduced, and a material cost may also be reduced. In addition, even if issues such as thermal runaway occur inside the battery module 100 and high temperature/high pressure gas and flames are generated, they may be easily discharged to the outside. FIG. 3 is a schematic view of a case where thermal runaway occurs in the battery module as described above. That is, as indicated by an inverted triangle, the internal high temperature/high pressure gas and flames may be quickly discharged to the outside through the empty space between the upper plates 220. Thereby, it is possible to prevent explosion, etc. from accumulating the high temperature/high pressure gas and the flame inside the battery module 100, thereby improving the safety of the battery module 100.

At both ends of the upper plate 220, a coupling portion 222 extending toward the U-shaped frame 210 is included. That is, in the drawing, the coupling portion 222 is formed to cover the upper portion of the side surface of the U-shaped frame 210 when the upper plate 220 and the U-shaped frame 210 are coupled by extending from the y-axis direction end of the upper plate 220 to the z-axis direction lower portion.

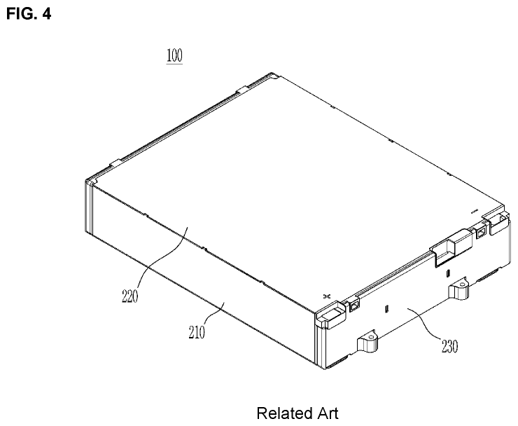

The coupling portion 222 may be coupled to the upper portion of the side of the U-shaped frame 210 by a method such as welding, bolting, adhesive, or snap fit, but is not particularly limited. In the present exemplary embodiment, the combination of the upper plate 220 and the U-shaped frame 210 is not made in the entire corner of the upper part of the side of the U-shaped frame 210, but only in the contact part with the upper plate 220 excluding the empty space, thereby increasing the assembly efficiency when manufacturing the battery module 100. That is, as shown in FIG. 4 showing a conventional battery module 100, since the welding is performed along the entire upper edge of the U-shaped frame 210, the time and cost for the welding increase. On the other hand, according to the present exemplary embodiment, since the portion in contact with the U-shaped frame 210 and the upper plate 220 is reduced, the welding area may also be reduced, and even by methods such as a bolting, an adhesive, and a snap-fit rather than the welding, as the firm bond is possible with fewer bonding points, the assembly efficiency may be greatly improved.

Also, according to the conventional structure shown in FIG. 4, since the entire upper surface of the stack of battery cells 110 is covered by the upper plate 220, even if the flame and the high temperature/high pressure gas are generated by the thermal runaway, there is a risk of an explosion of the battery module 100 because it is difficult to discharge them to the outside, in order to prevent this, a separate discharge hole or the like must be provided on the upper plate or the end plate, which complicates the manufacturing process. On the other hand, in the present exemplary embodiment, as described above, even if the issues such as the thermal runaway occur in the stack of battery cells 110 and the high temperature/high pressure gas and the flames occur, since it is possible to quickly discharge them to the outside through the empty space between the upper plate 220, it is possible to prevent the explosion of the battery module 100 by the accumulated heat and gas, and thus the safety of the battery module 100 may be improved.

On the other hand, the coupling portion 222 of the upper plate 220, as shown in FIG. 1, for example, may include a hook portion 222a in which a protrusion protruded toward the stack of battery cells is formed, and in this case, the U-shaped frame 210 may include a coupling hole 210a coupled to the protrusion. According to this, the upper plate 220 and the U-shaped frame 210 may be coupled by a snap-fit method. That is, when combining the upper plate 220 to the U-shaped frame 210 from the upper portion, while the protrusion is first in contact with the upper part of the U-shaped frame 210, and the coupling portions 222 of both ends of the upper plate 220 are slightly opened outward and combined with the U-shaped frame 210, the protrusion may be coupled until it is inserted into the coupling hole 210a. However, this is an example of a coupling method, and unlike this, a hole may be formed on the upper plate 220 side, a protrusion may be formed on the outer surface of the U-shaped frame 210, or other types of the snap-fit coupling are possible. In addition, as illustrated in the above, the bonding by the welding, the bolting, the adhesive, etc. is also possible.

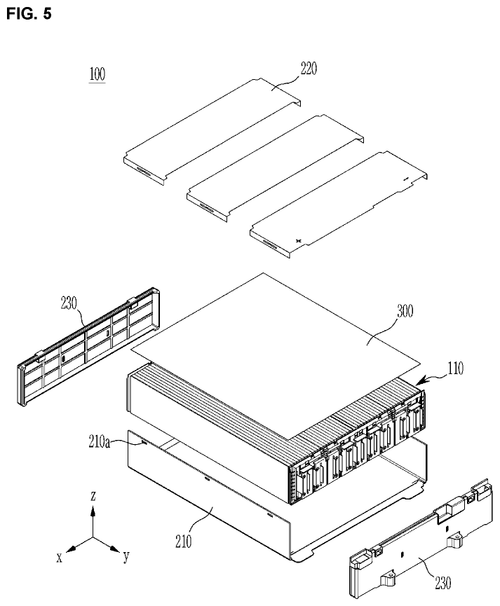

FIG. 5 is an exploded perspective view of a battery module according to another exemplary embodiment of the present disclosure.

Another exemplary embodiment of the present disclosure may further include a protection sheet 300 on the upper portion of the stack of battery cells 110. That is, by providing the protection sheet 300 formed of an insulating material, etc., on the stack of battery cells 110, it is possible to prevent the stack of battery cells 110 from being damaged in the assembly process of the upper plate 220, etc., in addition, it is possible to prevent the stack of battery cells 110 or internal electronic components from being damaged by the empty space between the upper plate 220.

As above described, according to an exemplary embodiment of the present disclosure, by configuring the upper plate 220 of the module frame 210 and 220 as a plurality of upper plate 220 covering the part of the upper part of the stack of battery cells 110, and configuring the empty space between the neighboring upper plates 220, It is possible to improve the assembly efficiency and to reduce the cost by reducing the material cost. In addition, even if the issues such as the thermal runaway occur in the stack of battery cells 110 and the high temperature/high pressure gas and the flame are generated, it is possible to quickly discharge to the outside through the empty space between the upper plate 220, and it is possible to prevent the explosion of the battery module 100 by the accumulated heat and gas, and thus the safety of the battery module 100 may be improved.

The battery module described above may be included in the battery pack. The battery pack may have a structure in which one or more battery modules according to the present exemplary embodiment are collected and a battery management system (BMS) that manages a temperature or voltage of the battery and a cooling device are added and packed.

The battery pack may be applied to various devices. Such a device may be a transportation means such as an electric bicycle, an electric vehicle, a hybrid vehicle, etc., but the present disclosure is not limited to this, and may be applied to various devices capable of using the battery module and the battery pack including the same, which belongs to the scope of the present disclosure.

While this disclosure has been described in connection with what is presently considered to be practical exemplary embodiments, it is to be understood that the disclosure is not limited to the disclosed embodiments. On the contrary, it is intended to cover various modifications and equivalent arrangements included within the spirit and scope of the appended claims.

### DESCRIPTION OF REFERENCE NUMERALS

110: stack of battery cells
210: U-shaped frame
220: upper plate
230: end plate
222: coupling portion

1. A battery module comprising:
a stack of battery cells;
a U-shaped frame that accommodates the stack of battery cells and has an opened upper part; and
at least two upper plates covering a part of the stack of battery cells at the opened upper part of the U-shaped frame.

2. The battery module of claim 1, wherein
a part where two adjacent upper plates among the at least two upper plates are spaced apart from each other is an empty space.

3. The battery module of claim 1, wherein
the upper plate is a strap shape such that both ends of the upper plate are joined to upper part of the U-shaped frame.

4. The battery module of claim 3, wherein
the upper plate includes a coupling portion extending toward the U-shaped frame at both ends.

5. The battery module of claim 4, wherein
the coupling portion of the upper plate and the U-shaped frame are coupled by any one of a welding, a bolting, an adhesive, and a snap fit.

6. The battery module of claim 5, wherein
the coupling portion of the upper plate and the U-shaped frame are coupled by a snap fit,
the coupling portion includes a hook portion in which a protrusion protruded toward the stack of battery cells is formed, and
the U-shaped frame includes a coupling hole that engages the protrusion.

7. The battery module of claim 2, wherein
the empty space acts as a vent hole.

8. The battery module of claim 1, further comprising:
a protection sheet disposed between the upper plate and the stack of battery cells.

9. A battery pack comprising:
the battery module of claim 1; and
a pack case packaging the battery module.

10. A device comprising the battery pack of claim 9.
